(19) United States
(12) Patent Application Publication
(10) Pub. No.: US 2021/0042806 A1
(43) Pub. Date: Feb. 11, 2021

(54) INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Jun UCHIMURA, Tokyo (JP); Hiroshi TAKAHASHI, Kanagawa (JP)

(73) Assignee: NEC Corporation, Minato-ku, Tokyo (JP)

(21) Appl. No.: 16/977,909

(22) PCT Filed: Feb. 22, 2019
(86) PCT No.: PCT/JP2019/006864

§ 371 Date: Sep. 3, 2020

(30) Foreign Application Priority Data
Mar. 5, 2018 (JP) 2018-038757

(51) Int. Cl. G06Q 30/06; H04W 4/024; G06Q 30/02; G07C 11/00; G01S 17/08; G01S 7/481

(52) U.S. Cl. CPC G06Q 30/0613; H04W 4/024; G06Q 30/0281; G07C 11/00; G06Q 20/202; G06Q 30/0639; G01S 17/08; G01S 7/4814; G06Q 30/0201

(57) ABSTRACT

Provided is an information processing system including: a detection means for detecting a position of a customer; and a display information generation means for generating display information used for displaying a notification to guide the customer to a place where the customer is going in accordance with a position of the customer.

### TECHNICAL FIELD

The present invention relates to an information processing system, an information processing method, and a storage medium.

### BACKGROUND ART

Patent Literature 1 discloses a point of sales (POS) register apparatus having a product registration apparatus and an adjustment apparatus. The product registration apparatus has a monitor for a customer, and a predicted value of waiting time or the like is displayed on the monitor.

Patent Literature 2 discloses a POS system including a customer terminal. On a display region of the customer terminal, information on a register lane on which a customer has to move or the like is displayed.

### CITATION LIST

### Patent Literature

PTL1: International Publication No. WO2017/056436

PTL2: Japanese Patent Application Laid-open No. 2002-222465

### SUMMARY OF INVENTION

### Technical Problem

Patent Literature 1 and Patent Literature 2 disclose that a notification to customers is displayed on a display device. In this scheme, however, a display position of the notification is not always appropriate for customers for some positional relationship between the customer and the display device.

The present invention has been made in view of the above problem and intends to provide an information processing system, an information processing method, and a storage medium that can display a notification at a more appropriate position.

### Solution to Problem

According to one example aspect of the present invention, provided is an information processing system including: a detection means for detecting a position of a customer; and a display information generation means for generating display information used for displaying a notification to guide the customer to a place where the customer is going in accordance with a position of the customer.

According to another example aspect of the present invention, provided is an information processing method including: detecting a position of a customer; and generating display information used for displaying a notification to guide the customer to a place where the customer is going in accordance with a position of the customer.

According to yet another example aspect of the present invention, provided is a storage medium storing a program that causes a computer to perform: detecting a position of a customer; and generating display information used for displaying a notification to guide the customer to a place where the customer is going in accordance with a position of the customer.

### Advantageous Effects of Invention

According to the present invention, an information processing system, an information processing method, and a storage medium that can display a notification at a more appropriate position can be provided.

### BRIEF DESCRIPTION OF DRAWINGS

FIG. 1 is a block diagram illustrating a general configuration of a POS system according to a first example embodiment.

FIG. 2 is a schematic diagram illustrating the arrangement of the POS system according to the first example embodiment.

FIG. 3 is a block diagram illustrating an example of a hardware configuration of an information processing system according to the first example embodiment.

FIG. 4 is a function block diagram of the information processing system according to the first example embodiment.

FIG. 5 is a flowchart illustrating an outline of a process performed by the information processing system according to the first example embodiment.

FIG. 6 is a schematic diagram illustrating an outline of customer guidance performed in the POS system according to the first example embodiment.

FIG. 7 is a schematic diagram illustrating an outline of customer guidance performed in a POS system according to a second example embodiment.

FIG. 8 is a schematic diagram illustrating an outline of customer guidance performed in a POS system according to a third example embodiment.

FIG. 9 is a function block diagram of an information processing system according to a fourth example embodiment.

### DESCRIPTION OF EMBODIMENTS

Exemplary example embodiments of the present invention will be described below with reference to the drawings. In the drawings, the same components or corresponding components are labeled with the same reference symbols, and the description thereof may be omitted or simplified.

### First Example Embodiment

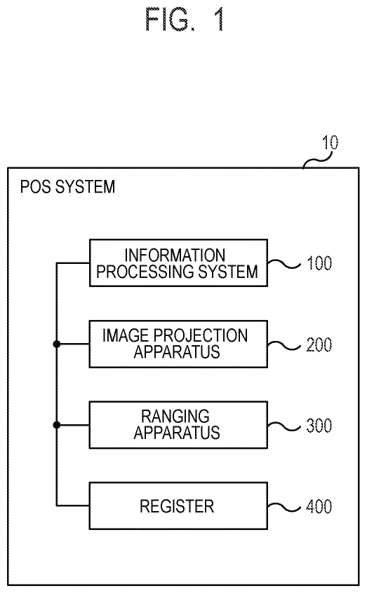

FIG. 1 is a block diagram illustrating a general configuration of a POS system 10 according to the present example embodiment. The POS system 10 is a system that performs registration of a product, payment, or the like when selling the product or the like in a shop. The POS system 10 includes an information processing system 100, an image projection apparatus 200, a ranging apparatus 300, and a register 400. The information processing system 100, the image projection apparatus 200, the ranging apparatus 300, and the register 400 are connected to each other so as to be able to communicate with each other by a wired or wireless manner. Note that the POS system 10 may be used for payment of the price for a provided service.

The information processing system 100 is a computer, for example, and performs processing such as control of each apparatus forming the POS system 10, acquisition of information from each apparatus, or analysis of the acquired information. The image projection apparatus 200 is an apparatus such as a transmission type liquid crystal projector or a reflection type liquid crystal projector and emits a beam to display an image such as a text, a figure, a symbol, or a picture on an object.

The ranging apparatus 300 is an apparatus such as a stereo camera apparatus or a Light Detection and Ranging (LiDAR) device and can acquire a spatial distribution of the distance from the ranging apparatus 300 to a ranging target.

The register 400 is an apparatus having a function such as registration of a product to be purchased or acceptance of payment. The register 400 has a barcode reader, a two-dimensional code reader, a Radio Frequency Identifier (RFID) reader, or the like for registration of a product. The register 400 acquires identification information from a medium provided to the product by using these readers and registers the product. The information processing system 100 or the register 400 acquires an amount to be paid by calculating the total amount of registered products. Further, the information on registered products is stored in a database of the POS system 10 and used for inventory management, calculation of a sales amount, or the like.

The register 400 further has a cash feeding port, an automatic change machine, a card reader, or the like. These apparatuses cause the register 400 to be able to accept payment by cash or payment by a credit card, a debit card, electronic money, or the like other than cash. That is, the register 400 is an adjustment place provided in the shop. Note that the register 400 may accept only payment by cash or may accept only payment by a credit card or the like other than cash. Further, the register 400 has a display device such as a liquid crystal display or an organic light emitting diode (OLED) display for displaying payment information or the like.

The display device of the register 400 displays information such as a product name, or the number of products, payment amount of a payment target, a number of a credit card or the like that can be used for payment, or an operation instruction to a customer 500. Note that the register 400 may be separated into a plurality of apparatuses such as a payment terminal and a product register apparatus.

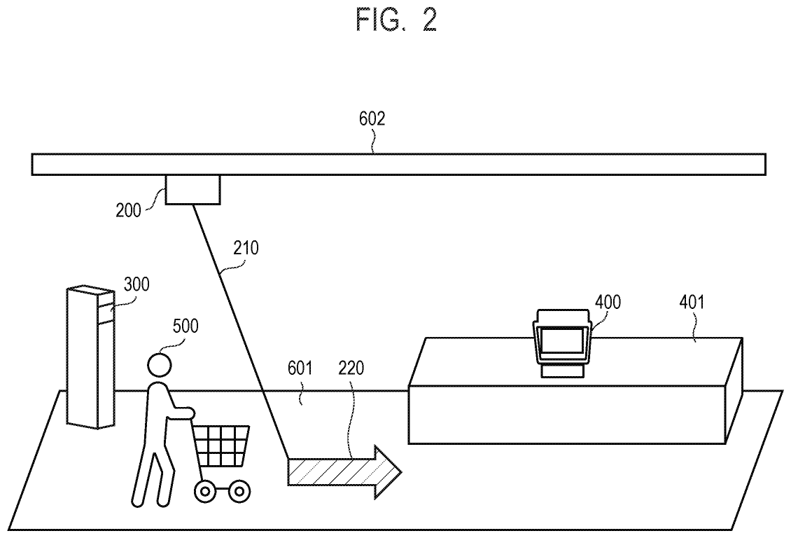

FIG. 2 is a schematic diagram illustrating the arrangement of a plurality of apparatuses in the POS (Point Of Sales) system 10 according to the present example embodiment. A lane for purchasing products illustrated in FIG. 2 is a self-service type unmanned lane in which the customer 500 who purchases a product performs product registration, payment, or the like by himself/herself. The use of the unmanned lane is an example, and a manned lane in which a salesclerk supports at least any one of product registration and payment may be employed, for example.

The ranging apparatus 300 performs ranging within a predetermined ranging range including the customer 500 who is near the register 400. For example, the ranging may be three-dimensional measurement to measure the distance in the depth direction while scanning two directions of the vertical direction and the horizontal direction. In such a case, three-dimensional information in the range including a position near the register 400 can be obtained. Note that, when the ranging apparatus 300 is a LiDAR device, the ranging accuracy in the depth direction can be improved compared to the case where a stereo camera or the like is employed. Although the type of a laser light source used for such a LiDAR device is not particularly limited, the case where the laser light source is a laser light source that emits invisible light such as infrared ray is more desirable because the ranging light does not give discomfort to the customer 500. The method of utilizing the information acquired by the ranging apparatus 300 will be described later.

The image projection apparatus 200 is arranged on a ceiling 602 of the shop. The image projection apparatus 200 displays a projection image 220 on a floor surface 601 by irradiating the floor surface 601 of the shop with a beam 210. The image projection apparatus 200 has a mechanism that can change, in a predetermined range, the direction in which the beam 210 is emitted. In such a way, the image projection apparatus 200 can display the projection image 220 at a position in accordance with control of the information processing system 100. Note that the main component of the beam 210 emitted from the image projection apparatus 200 are desirably visible light so that the customer 500 can view the projection image 220. As illustrated in FIG. 2, the projection image 220 may be an image for a notification that guides the customer 500 to a place where the customer 500 is going, such as an image of an arrow for guiding the customer 500 to the register 400, for example. A specific content of the projection image 220 will be described later.

Note that the position at which the image projection apparatus 200 is arranged is not limited to the ceiling 602 of a shop and may be a wall surface, a pillar, or the like of the shop, for example. Further, the position to which the projection image 220 is projected is not limited to the floor surface 601 of the shop and may be a wall surface, a pillar, or the like of the shop, for example.

The register 400 is provided on a register table 401. The register table 401 forms a payment lane in the shop. Although FIG. 2 illustrates one register 400 and one register table 401, a plurality of registers 400 and register tables 401 may be arranged.

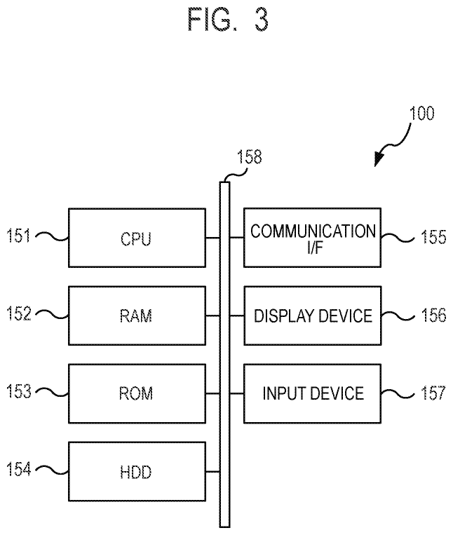

Next, a configuration and an operation of the information processing system 100 will be described. FIG. 3 is a block diagram illustrating an example of a hardware configuration of the information processing system 100. The information processing system 100 may be a computer, for example. The information processing system 100 may be a computer provided inside the image projection apparatus 200, the ranging apparatus 300, or the register 400.

The information processing system 100 has a central processing unit (CPU) 151, a random access memory (RAM) 152, a read only memory (ROM) 153, and a hard disk drive (HDD) 154 as a computer that performs calculation, control, and storage. The information processing system 100 further has a communication interface (I/F) 155, a display device 156, and an input device 157. The CPU 151, the RAM 152, the ROM 153, the HDD 154, the communication I/F 155, the display device 156, and the input device 157 are connected to each other via a bus 158. Note that the display device 156 and the input device 157 may be connected to the bus 158 via a drive device (not illustrated) used for driving these devices.

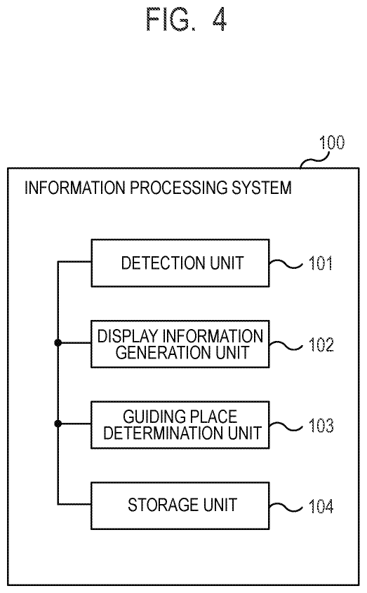

While respective components forming the information processing system 100 are illustrated as an integrated device in FIG. 4, some of these functions may be provided by an external device. For example, the display device 156 and the input device 157 may be an external device independent of a part forming the function of a computer including the CPU 151 and the like.

The CPU 151 has a function of performing a predetermined operation in accordance with a program stored in the ROM 153, the HDD 154, or the like and also controlling each component of the information processing system 100. The RAM 152 is formed of a volatile storage medium and provides a temporary memory area necessary for the operation of the CPU 151. The ROM 153 is formed of a nonvolatile storage medium and stores necessary information such as a program used for the operation of the information processing system 100. The HDD 154 is a storage device that is formed of a nonvolatile storage medium and stores data required for processing, a program for operating the information processing system 100, or the like.

The communication I/F 155 is a communication interface based on the specification such as Ethernet (registered trademark), Wi-Fi (registered trademark), 4G, or the like, which is a module used for communicating with other devices. The display device 156 is a liquid crystal display, an OLED display, or the like and is used for displaying an image, a text, an interface, or the like. The input device 157 is a keyboard, a pointing device, or the like and is used by the user for operating the information processing system 100. An example of the pointing device may be a mouse, a trackball, a touch panel, or the like. The display device 156 and the input device 157 may be integrally formed as a touch panel.

Note that the hardware configuration illustrated in FIG. 3 is an example, and a device other than the above may be added, or some of the devices may not be provided. Further, some of the devices may be replaced with another device having the same function. Furthermore, a part of the function of the present example embodiment may be provided by another device via a network, the function of the present example embodiment may be implemented by being distributed in a plurality of devices. For example, the HDD 154 may be replaced with a solid state drive (SSD) using a semiconductor memory or may be replaced with cloud storage.

FIG. 4 is a function block diagram of the information processing system 100 according to the present example embodiment. The information processing system 100 has a detection unit 101, a display information generation unit 102, a guiding-place determination unit 103, and a storage unit 104.

The CPU 151 implements functions of the detection unit 101, the display information generation unit 102, and the guiding-place determination unit 103 by loading a program stored in the ROM 153, the HDD 154, or the like to the RAM 152 and executing the program. Processes performed on respective units will be described later. The CPU 151 implements a function of the storage unit 104 by controlling the HDD 154.

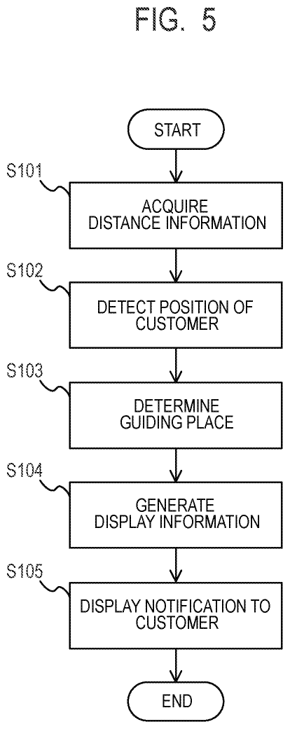

FIG. 5 is a flowchart illustrating a process performed by the information processing system 100 according to the present example embodiment. A payment-related process performed by the information processing system 100 will be described with reference to FIG. 5.

In step S101, the information processing system 100 instructs the ranging apparatus 300 to perform ranging within a range including a position near the register 400. The ranging apparatus 300 performs ranging in response to the instruction. The distance information obtained by the ranging is transmitted to the information processing system 100 and stored in the storage unit 104 if necessary.

In step S102, the detection unit 101 detects the position of the customer 500 based on distance information obtained by the ranging apparatus 300. Note that the detection in this process may detect all the customers 500 in a predetermined range or may detect a predetermined number of customers 500 in ascending order of distance to the register 400, for example.

In step S103, the guiding-place determination unit 103 determines a guiding place where the customer 500 detected by the detection unit 101 is going. The guiding place may be any of the plurality of registers 400, for example. As a specific example of a method of determining a guiding place in the present example embodiment, guiding to an empty register 400 that completed the previous process may be considered.

In step S104, the display information generation unit 102 generates display information used for displaying a notification to guide the customer 500 to a place where he/she is going in accordance with the position of the customer 500 detected by the detection unit 101. The display information is provided from the information processing system 100 to the image projection apparatus 200.

In step S105, based on the display information generated by the display information generation unit 102, the image projection apparatus 200 displays the projection image 220 to a place in accordance with the position of the customer 500. It is desirable that the display place of the projection image 220 be a place easily viewed by the customer 500 such as the floor surface 601 at the customer 500's feet or the floor surface 601 near the cart held by the customer 500, for example.

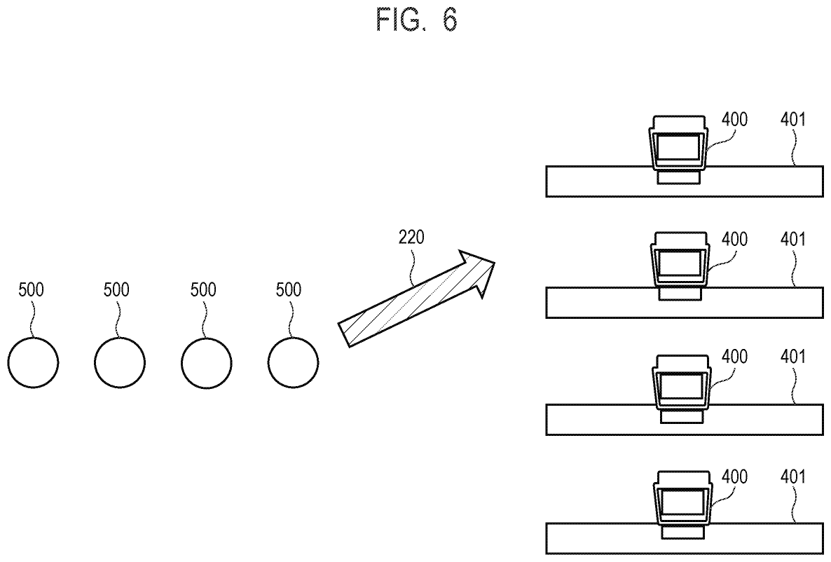

An example of the customer guidance by displaying the projection image 220 will be described with reference to FIG. 6. FIG. 6 is a schematic diagram illustrating an outline of the customer guidance performed in the POS system 10 according to the present example embodiment. In the shop in the example of FIG. 6, a waiting method in which the plurality of customers 500 stand in a line is employed. Each customer 500 is guided to the register 400 determined by the guiding-place determination unit 103 out of the plurality of registers 400. FIG. 6 illustrates an example of display of the projection image 220 when the first customer 500 is guided to the register 400 on the first row. In this example, by displaying the starting point of the arrow to a position near the first customer 500, the first customer 500 can recognize that he/she is guided. Further, by directing the end point of the arrow to the register 400 that is the guiding place, the first customer 500 can recognize the register 400 that is the guiding place.

The customers 500 spontaneously form a line and stand in the line in front of the plurality of registers 400. Thus, the positions of the customers 500 are not always the same. Thus, in the scheme for guiding customers by using a display device such as a liquid crystal display whose display position is fixed, the guidance display is not always displayed in the place easily viewed by the customer 500.

On the other hand, in the present example embodiment, the detection unit 101 detects the position of the customer 500 and causes a notification to be displayed at the position in accordance with the detected position, and thereby the notification to the customer 500 can be displayed at the appropriate position for the customer 500. Therefore, according to the present example embodiment, the information processing system that can display a notification at a more appropriate position is provided.

### Second Example Embodiment

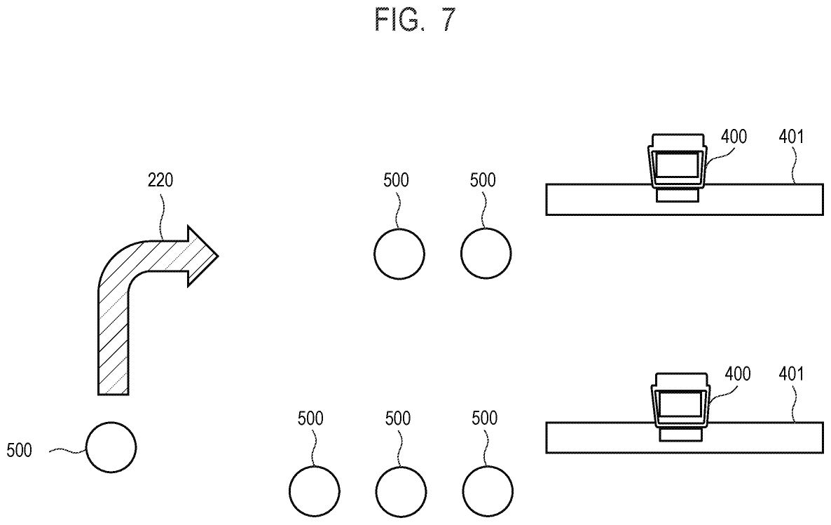

FIG. 7 is a schematic diagram illustrating an outline of customer guidance performed in the POS system 10 according to the present example embodiment. An example of the customer guidance in the present example embodiment will be described with reference to FIG. 7. Note that, in the description of the present example embodiment, the description of a part duplicated with the first example embodiment may be omitted or simplified.

In the example of FIG. 7, a waiting method in which a plurality of customers 500 stand in respective lines for a plurality of registers 400 is employed. The customer 500 who newly visits is guided to the register 400 determined by the guiding-place determination unit 103 out of the plurality of registers 400. FIG. 7 illustrates an example of display of the projection image 220 when the customer 500 who newly visits is guided to the register 400 on the first row. In this example, by displaying the starting point of the arrow at a position near the first customer 500, the first customer 500 can recognize that he/she is guided. Further, by directing the end point of the arrow to the register 400 that is the guiding place, the first customer 500 can recognize the register 400 that is the guiding place.

A specific example of a method of determining the guiding place in the present example embodiment will be described. In the terms of minimizing the waiting time of the customers 500 and improving throughput of the registers 400, it is desirable that the customer 500 who newly approaches a plurality of registers 400 be guided to the register 400 with the shortest required time. Accordingly, for example, when the guiding-place determination unit 103 calculates an estimated required time of a procedure in each of the plurality of registers 400, the register 400 with the shortest estimated required time can be determined as the guiding place.

An example of a method of calculating an estimated required time will be described. When the number of waiting persons of each register 400 is calculated based on the past guidance result and the processing status of each register 400, the estimated required time can be calculated. Further, as another example, when the ranging apparatus 300 ranges a part near each register 400 and the detection unit 101 detects the position of the customer 500 from the distance information, the number of waiting customers 500 who stand in the line near each register 400 can be acquired, and the estimated required time can be calculated.

For example, in the example of FIG. 7, the number of waiting persons for the register 400 on the first row is two, and the number of waiting persons for the register 400 on the second row is three. If the required time per one person is the same, the waiting time for the register 400 on the first row is shorter than the waiting time for the register 400 on the second row. Thus, the customer 500 who newly visits is guided to the register 400 on the first row.

Since the positions of the customers 500 who visit the plurality of registers 400 are changed depending on the length of a line or the like, the positions are not always the same. Thus, in a scheme for guiding the customer by using a display device such as a liquid crystal display whose display position is fixed, the guidance display is not always displayed in the place easily viewed by the customer 500.

Also in the present example embodiment, however, when the detection unit 101 detects the position of the customer 500 and displays a notification to the place in accordance with the detected position, a notification to the customer 500 can be displayed at an appropriate place for the customer 500. Therefore, according to the present example embodiment, as with the case of the first example embodiment, the information processing system that can display a notification at a more appropriate position is provided.

Note that the scheme of determining a guiding place by the guiding-place determination unit 103 may be a scheme for referencing information other than the estimated required time. For example, when available payment methods are different for respective registers 400, a guiding place may be determined with reference to the information on a payment method registered by the customer 500 in advance. In such a case, it is possible to perform guiding to an appropriate register 400 taking the payment method into consideration.

### Third Example Embodiment

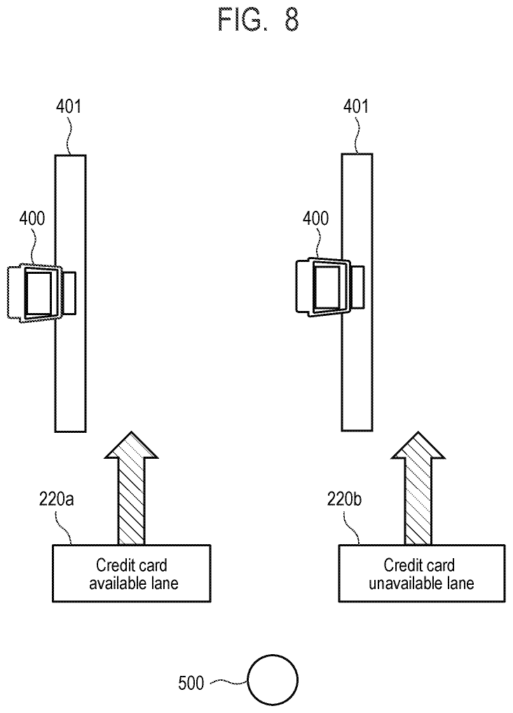

FIG. 8 is a schematic diagram illustrating an outline of customer guidance performed in the POS system 10 according to the present example embodiment. An example of customer guidance in the present example embodiment will be described with reference to FIG. 8. Note that, in the description of the present example embodiment, the description of a part duplicated with the first example embodiment or the second example embodiment will be omitted or simplified.

The example of FIG. 8 illustrates a guiding method when one of the two registers 400 is the register 400 that can handle payment with a credit card and the other is the register 400 that cannot handle payment with a credit card. As described above, when payment methods that are available in the registers 400 are different, the customer 500 who wants to make payment by cash and the customer 500 who wants to make payment by a credit card are required to be guided to different registers 400. Accordingly, in the example of FIG. 8, text information of “Credit card available lane” is added to a projection image 220a, and text information of “Credit card unavailable lane” is added to a projection image 220b. In such a way, the information on a payment method that is available at the register 400 is added to each of the projection images 220a and 220b. As described above, the customer 500 may recognize the register 400 that can handle his/her desired payment method and move to the appropriate register 400.

In the present example embodiment, the information processing system that can display a notification at a more appropriate position as with the first example embodiment or the second example embodiment is provided. Further, in the present example embodiment, by displaying additional information such as text information, it is possible to notify the customer of further information.

Note that the text information that can be described in the projection images 220a and 220b is not limited to a payment method. For example, such text information may be display as to whether or not the register 400 is self-system, display of an express lane that can be used by only the customer 500 who has a small number of products, or the like. Further, information to be added to the projection images 220a and 220b may not be a text and may be illustrated information to be notified.

The system described in the above example embodiments can also be configured as described in a fourth example embodiment described below.

### Fourth Example Embodiment

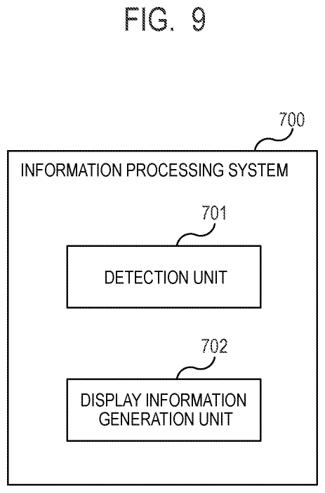

FIG. 9 is a function block diagram of an information processing system 700 according to the present example embodiment. The information processing system 700 has a detection unit 701 and a display information generation unit 702. The detection unit 701 detects the position of a customer. The display information generation unit 702 generates display information used for displaying a notification to guide the customer to a place where the customer is going in the place in accordance with the position of the customer.

According to the present example embodiment, the information processing system 700 that can display a notification at a more appropriate position is provided.

### Modified Example Embodiment

The present invention is not limited to the example embodiments described above and can be changed as appropriate without departing from the spirit of the present invention.

In the above example embodiments, the ranging apparatus 300 may be replaced with an apparatus such as a still camera or a video camera that does not perform ranging. In such a case, the position of the customer 500 is calculated from a captured image by using various image analysis techniques, and the same process can be performed based thereon. However, it is desirable to employ the ranging apparatus 300 that can acquire a distance.

Although the notification to guide the customer 500 to a place where he/she is going is performed by displaying the projection image 220 by the image projection apparatus 200 in the above example embodiments, a method of notifying the customer 500 is not limited thereto. For example, when a plurality of display devices are embedded in the floor surface of a shop, the information processing systems 100 and 700 may display a notification to guide the customer 500 to a place where the customer 500 is going on a display device installed in a place in accordance with the position of the customer 500. For example, in selection of a display device that displays a notification, an algorithm in which a notification to guide the customer 500 to a place where the customer 500 is going is displayed on a display device that is the closest to the customer 500 out of a plurality of display devices in the shop may be employed. In such a case, the same advantages as those of the above example embodiments is obtained as well. In this example, the installation place of the plurality of display devices may be a wall surface, a ceiling, a door, a product display shelf, a register table, or the like other than the floor surface.

The scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the program itself. Further, one or two or more components included in the example embodiments described above may be a circuit such as an application specific integrated circuit (ASIC), a field programmable gate array (FPGA), or the like configured to implement the function of each component.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

Further, a service implemented by the function of each of the example embodiments described above may be provided to a user in a form of Software as a Service (SaaS).

Note that all the example embodiments described above are mere embodied examples in implementing the present invention, and the technical scope of the present invention should not be construed in a limiting sense by these example embodiments. That is, the present invention can be implemented in various forms without departing from the technical concept thereof or the primary feature thereof.

The whole or part of the example embodiments disclosed above can be described as, but not limited to, the following supplementary notes.

### (Supplementary Note 1)

An information processing system comprising:

a detection means for detecting a position of a customer; and

a display information generation means for generating display information used for displaying a notification to guide the customer to a place where the customer is going in accordance with a position of the customer.

### (Supplementary Note 2)

The information processing system according to supplementary note 1, wherein the notification is for guiding the customer to a predetermined place.

### (Supplementary Note 3)

The information processing system according to supplementary note 1 or 2, wherein the notification is for guiding the customer to any of a plurality of adjustment places provided in a shop.

### (Supplementary Note 4)

The information processing system according to supplementary note 3, wherein the adjustment place that is a guiding place for the customer is determined in accordance with an estimated required time of a procedure in each of the plurality of adjustment places.

### (Supplementary Note 5)

The information processing system according to supplementary note 4, wherein the estimated required time is acquired based on the number of waiting persons who wait for a procedure in each of the plurality of adjustment places.

### (Supplementary Note 6)

The information processing system according to supplementary note 5, wherein the detection means acquires information used for calculation of the number of waiting persons by detecting a position of the customer who is near each of the plurality of adjustment places.

### (Supplementary Note 7)

The information processing system according to supplementary note 3, wherein the adjustment place that is a guiding place for the customer is determined in accordance with a payment method that is available in each of the plurality of adjustment places.

### (Supplementary Note 8)

The information processing system according to any one of supplementary notes 3 to 7, wherein the notification includes information on a payment method that is available in each of the plurality of adjustment places.

### (Supplementary Note 9)

The information processing system according to any one of supplementary notes 1 to 8, wherein the detection means detects a position of the customer based on distance information acquired by a ranging apparatus that acquires a distance to a ranging target.

### (Supplementary Note 10)

The information processing system according to supplementary note 9, wherein the ranging apparatus includes a Light Detection and Ranging (LiDAR) device.

### (Supplementary Note 11)

The information processing system according to supplementary note 10, wherein the LiDAR device includes a laser light source that emits invisible light.

### (Supplementary Note 12)

The information processing system according to any one of supplementary notes 1 to 11, wherein the display information is supplied to an image projection apparatus that displays an image including the notification by emitting visible light.

### (Supplementary Note 13)

The information processing system according to supplementary note 12, wherein the image projection apparatus displays the image on a floor surface of a shop.

### (Supplementary Note 14)

The information processing system according to supplementary note 13, wherein the image projection apparatus displays the image near the customer.

### (Supplementary Note 15)

An information processing method comprising:

detecting a position of a customer; and

generating display information used for displaying a notification to guide the customer to a place where the customer is going in accordance with a position of the customer.

### (Supplementary Note 16)

A storage medium storing a program that causes a computer to perform:

detecting a position of a customer; and

generating display information used for displaying a notification to guide the customer to a place where the customer is going in accordance with a position of the customer.

This application is based upon and claims the benefit of priority from Japanese Patent Application No. 2018-038757, filed on Mar. 5, 2018, the disclosure of which is incorporated herein in its entirety by reference.

### REFERENCE SIGNS LIST

10 POS system
100, 700 information processing system
101, 701 detection unit
102, 702 display information generation unit
103 guiding-place determination unit
104 storage unit
151 CPU
152 RAM
153 ROM
154 HDD
155 communication I/F
156 display device
157 input device
158 bus
200 image projection apparatus
210 beam
220, 220a, 220b projection image
300 ranging apparatus
400 register
401 register table
500 customer
601 floor surface
602 ceiling

What is claimed is:

1. An information processing system comprising:
a detection unit that detects a position of a customer; and
a display information generation unit that generates display information used for displaying a notification to guide the customer to a place where the customer is going in accordance with a position of the customer.

2. The information processing system according to claim 1, wherein the notification is for guiding the customer to a predetermined place.

3. The information processing system according to claim 1, wherein the notification is for guiding the customer to any of a plurality of adjustment places provided in a shop.

4. The information processing system according to claim 3, wherein the adjustment place that is a guiding place for the customer is determined in accordance with an estimated required time of a procedure in each of the plurality of adjustment places.

5. The information processing system according to claim 4, wherein the estimated required time is acquired based on the number of waiting persons who wait for a procedure in each of the plurality of adjustment places.

6. The information processing system according to claim 5, wherein the detection unit acquires information used for calculation of the number of waiting persons by detecting a position of the customer who is near each of the plurality of adjustment places.

7. The information processing system according to claim 3, wherein the adjustment place that is a guiding place for the customer is determined in accordance with a payment method that is available in each of the plurality of adjustment places.

8. The information processing system according to claim 3, wherein the notification includes information on a payment method that is available in each of the plurality of adjustment places.

9. The information processing system according to claim 1, wherein the detection unit detects a position of the customer based on distance information acquired by a ranging apparatus that acquires a distance to a ranging target.

10. The information processing system according to claim 9, wherein the ranging apparatus includes a Light Detection and Ranging (LiDAR) device.

11. The information processing system according to claim 10, wherein the LiDAR device includes a laser light source that emits invisible light.

12. The information processing system according to claim 1, wherein the display information is supplied to an image projection apparatus that displays an image including the notification by emitting visible light.

13. The information processing system according to claim 12, wherein the image projection apparatus displays the image on a floor surface of a shop.

14. The information processing system according to claim 13, wherein the image projection apparatus displays the image near the customer.

15. An information processing method comprising:
detecting a position of a customer; and
generating display information used for displaying a notification to guide the customer to a place where the customer is going in accordance with a position of the customer.

16. A non-transitory storage medium storing a program that causes a computer to perform:
detecting a position of a customer; and
generating display information used for displaying a notification to guide the customer to a place where the customer is going in accordance with a position of the customer.
